(19) United States
(12) Patent Application Publication
(10) Pub. No.: US 2025/0077290 A1
(43) Pub. Date: Mar. 6, 2025

(54) DISTRIBUTED ARTIFICIAL INTELLIGENCE SOFTWARE CODE OPTIMIZER

(71) Applicant: BANK OF AMERICA CORPORATION, Charlotte, NC (US)

(72) Inventors: Joshua Abraham, Sharon, MA (US); Steven E. Sinks, Scottsdale, AZ (US)

(73) Assignee: BANK OF AMERICA CORPORATION, Charlotte, NC (US)

(21) Appl. No.: 18/240,450

(22) Filed: Aug. 31, 2023

(51) Int. Cl. G06F 9/50

(52) U.S. Cl. CPC G06F 9/5038; G06F 9/5044; G06F 9/5055

(57) ABSTRACT

Software code optimization for specific computerized tasks is achieved by utilizing task-specific ML models that are trained to determine optimal sets of software code by intelligently assessing available hardware resources (i.e., specifically, processing devices, such as CPUs and GPUs) and, in some instances, SDKs for a specified task and, as a result, determining an optimal set of software codes for the specified task that is tied to one or more of the available hardware resources.

### FIELD OF THE INVENTION

The present invention is related generally to optimizing software code and, more specifically, implementing machine learning and considering available hardware resources to determine the optimal software code, e.g., the most efficient software code in terms of speed and accuracy.

### BACKGROUND

The speed and accuracy/performance by which a computerized task is completed is dependent upon the set of software codes that is used. In this regard, the hardware resources, such as processing units/devices (e.g., Central Processing Units (CPUs), Graphics Processing Units (GPUs) and the like on which the set of software codes are executed have a significant impact on the speed and/or accuracy/performance that results from a given set of software codes. Other factors, such as the Software Development Kit (SDK) version specific to the computerized task may play a role in the speed and/or accuracy that results from a given set of software codes.

Further, in certain instances the rate or speed in which the computerized task is performed is the desired optimal characteristic of the set of software codes, while in other instances the accuracy/performance is the desired optimal characteristic of the set of software codes. While in further instances, optimization of the set of software codes may be in terms of trying to maximize both rate/speed and accuracy/performance of the computerized task, or at least achieving an appropriate balance between rate/speed and accuracy/performance of the computerized task.

Therefore, a need exists to intelligently determine which set of software codes for a specific computerized task is most optimal in terms of, at least speed/rate of performing the task and/or the accuracy of performance. In this regard, the desired systems, methods, computer program products and the like should take into account all of the available hardware resources (i.e., either all of the commercially hardware resources available or all of the hardware resources currently available within an entity/enterprise), as well as, in some instances the SDK version in determining which software code is optimal. Moreover, the desired systems, methods, computer program products should allow the user to define constraints around optimization, such that the determined set software code is optimized to meet the requisite user-defined constraints.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing for systems, methods, computer program products and the like that optimize sets of software codes. In this regard, the invention is capable of intelligently assessing all of the available hardware resources (i.e., specifically, processing devices, such as CPUs and GPUs) and, in some embodiments, SDKs for a specified task and, as a result, determining an optimal set of software codes for a specified task that is specific to one or more of the available hardware resources.

Specifically, the invention relies on Artificial Intelligence (AI) including Machine Learning (ML) models. The ML models are trained to generate sets of software code for a specific computerized task. In this regard, the ML models receive inputs that comprise, at a minimum, the available hardware resources and determines at least one set of codes for performing the computerized task with each set of codes seeking to optimize the performance of the computerized task and being dependent on specific available hardware resources (e.g., specific available processing devices). Optimization takes into account at least one, and in some embodiments both, rate/speed of performance and the accuracy of performance.

In specific embodiments, the ML models additionally receive inputs that define user-specified constraints (i.e., specific parameters that define the optimization that the set of software code is required to meet). In such embodiments, the ML models are configured to generate a single set of hardware resource-dependent software codes that has been determined to be most optimal. In other embodiments of the invention, in which the ML models do not receive user-specified constraint inputs, the ML models are configured to generate multiple sets of software codes, with each set of software codes being dependent on different hardware resources (e.g., different processing devices). In such embodiments of the invention, in which executing the ML models results in multiple sets of software codes, regression testing of the sets of software code is performed to determine which is set of software codes is the most optimal.

As a result, embodiments of the present invention, ensure that both the set of software codes and the hardware resources required to execute the set of software codes are optimal for performing the associated computerized task. Moreover, since the invention, considers all of the available hardware resources (e.g., available processing units, such as CPUs, GPUs and the like), large entities/enterprises and the like that make informed decisions on hardware resource allocation and/or acquisition.

A system for intelligent software code optimization defines first embodiments of the invention. The system includes a computing platform having a memory and one or more computing processor devices in communication with the processor. In addition, the system includes an Artificial Intelligence (AI) engine that is stored in the memory and executable by at least one of the one or more computing processing devices. The AI engine includes a plurality of Machine Learning (ML) models, each ML model is trained to generate software code for a specific task. In this regard, each ML model is configured to receive first inputs that define a plurality of currently available hardware resources for executing software code, and, in response to receiving the first inputs, generate at least one set of software codes for the specific task associated with the ML model. Each set of software codes are specific to at least one of the plurality of currently available hardware resources and one of the sets of software codes is a most optimal set of software codes for completing the specific task. The most optimal is defined by at least one of (i) a rate at which the specific task is completed, and (ii) an accuracy of completing the specific task. For example, the most optimal set of software codes may serve to maximize rate/speed of delivering the specific task and maximize the accuracy in which the specific task is accomplished. In those instances, in which the specified task and/or the software code does not allow for both the rate and accuracy to be maximized, the most optimal set of software codes will seek to balance the rate/speed.

In specific embodiments of the system, the hardware resources that serve as inputs to the ML models include processing units including, but not limited to, Central Processing Units (CPUs) and/or Graphics Processing Units (GPUs). In further specific embodiments of the invention, the currently available hardware resources may be the entire spectrum of currently commercially available hardware resources or those hardware resources currently available within the entity/enterprise executing the models (e.g., underutilized or unused processing units within the entity/enterprise or the like).

In other specific embodiments of the system, each ML model is further configured to receive second inputs that define at least one Software Development Kit (SDK) version associated with the specific task, and, in response to receiving the first and second inputs, generate at least one set of software codes for the specific task associated with the ML model. Where applicable, each set of software codes are specific to the at least one of the plurality of currently available hardware resources and one of the at least one SDK versions.

In further specific embodiments of the invention, each ML model is further configured to receive second inputs that define user-specified constraints for determining the most optimal set of software codes. The user-specified constraints define at least one of (i) required time constraints for completing the specific task, (ii) required accuracy constraints for completing the specific task, and (iii) resource acquisition (i.e., cost or the like) constraints for acquiring at least one of the currently available hardware resources. In related embodiments of the invention, in which the ML models receive second inputs that define user-specified constraints, each ML model is further configured to, in response to receiving the first and second inputs, generate one specific set of software codes that is the most optimal set of software codes for completing the task. In such embodiments of the system, the most optimal is further defined by the user-specified constraints.

In other embodiments of the invention, for example, in those embodiments in which the ML model inputs do not include user-specified constraints, each ML model is configured to generate a plurality of sets of software codes. In such embodiments the system additionally includes a regression test engine that is stored in the memory and executable by at least one of the one or more computing processor devices. The regression test engine is configured to perform regression testing on each of the plurality of sets of software codes to determine which one of the plurality of sets of software codes is the most optimal. In further related embodiments of the invention, the results from the regression test engine (i.e., the set of software codes determined to be most optimal) are fed back into the ML models so that, over time, the ML models learn.

In still further specific embodiments of the system, the ML models receive later inputs that define newly available hardware resources (e.g., new commercially available hardware resources or newly acquired/underutilized hardware resources of the entity/enterprise) and, in response, generate at least one set of software codes for the specific task associated with the ML model. Each set of software codes are specific to at least one of the plurality of currently available hardware resources or at least one of the one or more newly available hardware resources and one of the least one set of software codes is a most optimal set of software codes for completing the specific task. In this regard, the ML model determines whether the newly available hardware resources result in a set of software codes that are more optimal than previously determined sets of software code that use existing hardware resources.

A computer-implemented method for intelligently optimizing software code defines second embodiments of the invention. The method is executed by one or more computing processor devices. The method includes training a Machine Learning (ML) model to generate software code for a specific task. Once trained, the method further includes receiving, at the ML model, first inputs that define a plurality of currently available hardware resources for executing software code. In response to receiving at least the first inputs, the method includes executing the ML model to generate at least one set of software codes for the specific task. Each set of software codes that the ML model generates is specific to at least one of the plurality of currently available hardware resources. Further, one set of the software codes is a most optimal set of software codes for completing the specific task. The most optimal is defined by at least one of (i) a rate at which the specific task is completed, and (ii) an accuracy of completing the specific task.

In specific embodiments of the computer-implemented method, receiving the first inputs further includes receiving, at the ML model, the first inputs that define the plurality of currently available hardware resources for executing software code, wherein the plurality of currently available hardware resources include processing units including at least one of Central Processing Units (CPUs) and Graphics Processing Units (GPUs). In such embodiments of the computer-implemented method executing further includes executing the ML model to generate at least one set of software codes for the specific task, wherein each set of software codes are specific to at least one of the processing units.

In further specific embodiments the computer-implemented method includes receiving, at the ML model, second inputs that define at least one Software Development Kit (SDK) version associated with the specific task. In such embodiments of the computer-implemented method, executing further includes, in response to receiving the first and second inputs, execute the ML model to generate at least one set of software codes for the specific task, wherein each set of software codes are specific to the at least one of the plurality of currently available hardware resources and one of the at least one SDK versions.

In other specific embodiments the computer-implemented method includes receiving, at the ML model, second inputs that define user-specified constraints for determining the most optimal set of software codes. The user-specified constraints define at least one of (i) required time constraints for completing the specific task, (ii) required accuracy constraints for completing the specific task and (iii) resource acquisition constraints for acquiring at least one of the currently available hardware resources. In such embodiments of the computer-implemented method, executing further includes, in response to receiving the first and second inputs, executing the ML model to generate at least one set of software codes for the specific task, The at least one set of software codes is one specific set of software codes that is the most optimal set of software codes for completing the task, and the most optimal is further defined by the user-specified constraints.

In still further specific embodiments of the computer-implemented method, executing further includes executing the ML model to generate a plurality of sets of software codes. In such embodiments the computer-implemented method further includes performing regression testing on each of the plurality of sets of software codes to determine which one of the plurality of sets of software codes is the most optimal.

Moreover, in additional specific embodiments the computer-implemented method includes receiving, at the ML model, second inputs that define one or more newly available hardware resources for executing software code, and, in response to the first and second inputs, re-executing the ML models to generate at least one set of software codes for the specific task. Each set of software codes are specific to at least one of the plurality of currently available hardware resources or at least one of the one or more newly available hardware resources and one of sets of software codes is a most optimal set of software codes for completing the specific task.

A computer program product including a non-transitory computer-readable medium defines third embodiments of the invention. The computer-readable medium includes sets of codes for causing one or more computing devices to (i) train a Machine Learning (ML) model to generate software code for a specific task, (ii) receive, at the ML model, first inputs that define a plurality of currently available hardware resources for executing software code, and (iii) in response to receiving the first inputs, execute the ML model to generate at least one set of software codes for the specific task. Each set of software codes are specific to at least one of the plurality of currently available hardware resources and one of the least one set of software codes is a most optimal set of software codes for completing the specific task. The most optimal is defined by at least one of (i) a rate at which the specific task is completed, and (ii) an accuracy of completing the specific task.

In specific embodiments of the computer program product, the set of codes for causing the one or more computing devices to receive are further configured to cause the one or more computing devices to receive, at the ML model, the first inputs that define the plurality of currently available hardware resources including processing units comprising at least one of Central Processing Units (CPUs) and Graphics Processing Units (GPUs). In such embodiments of the computer program product the set of codes for causing the one or more computing device to execute are further configured to cause the one or more computing devices to execute the ML model to generate at least one set of software codes for the specific task, each set of software codes are specific to at least one of the processing units.

In other specific embodiments of the computer program product, the sets of codes further include a set of codes for causing the one or more computing devices to receive, at the ML model, second inputs that define at least one Software Development Kit (SDK) version associated with the specific task. In such embodiments of the computer program product, the set of codes configured to cause the one or more computing devices to execute are further configured to cause the one or more computing devices to, in response to receiving the first and second inputs, execute the ML model to generate at least one set of software codes for the specific task. Each set of software codes specific to at least one of the currently available hardware resources and one of the SDK versions.

In further specific embodiments of the computer program product, the sets of codes further include a set of codes for causing the one or more computing devices to receive, at the ML model, second inputs that define user-specified constraints for determining the most optimal set of software codes. The user-specified constraints define at least one of (i) required time constraints for completing the specific task, (ii) required accuracy constraints for completing the specific task, and (iii) resource acquisition constraints for acquiring at least one of the currently available hardware resources. In such embodiments of the computer program product, the set of codes configured to cause the one or more computing devices to execute are further configured to cause the one or more computing devices to, in response to receiving the first and second inputs, execute the ML model to generate one specific set of software codes that is the most optimal set of software codes for completing the task. The most optimal is further defined by the user-specified constraints.

Moreover, in additional specific embodiments of the computer program product, the set of codes configured to cause the one or more computing devices to execute are further configured to cause the one or more computing devices to execute the ML model generate a plurality of sets of software codes. In such embodiments of the computer program product, the sets of codes further include a set of codes for causing the one or more computing devices to perform regression testing on each of the plurality of sets of software codes to determine which one of the plurality of sets of software codes is the most optimal.

Thus, according to embodiments of the invention, which will be discussed in greater detail below, the present invention provides for optimizing set(s) of software codes for specific computerized tasks. The invention provides for utilizing ML model trained to determine optimal sets of software code by intelligently assessing available hardware resources (i.e., specifically, processing devices, such as CPUs and GPUs) and, in some embodiments, SDKs for a specified task and, as a result, determining an optimal set of software codes for a specified task that is specific to one or more of the available hardware resources.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block diagram of a system for intelligent software code generation and optimization, in accordance with embodiments of the present invention;

FIG. 2 is a block diagram of a computing platform for intelligent generation of optimized software code using Machine Learning (ML) models; in accordance with embodiments of the present invention;

FIG. 3 is a schematic/flow diagram of a method for intelligent generation of an optimized set of software code using ML models, in accordance with embodiments of the present invention;

FIG. 4 is a schematic/flow diagram of a method for intelligent generation of an optimized sets of software code using ML models and subsequent regression testing, in accordance with embodiments of the present invention;

FIG. 5 is a flow diagram of a method for intelligent generation of an optimized set of software code using ML models, in accordance with embodiments of the present invention, in accordance with embodiments of the present invention; and

FIG. 6 is schematic diagram flow diagram of an exemplary machine learning (ML) subsystem architecture, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, according to embodiments of the invention, which will be described in more detail below, systems, methods and computer program products are disclosed that providing for intelligently optimizing software code. In this regard, the invention is capable of intelligently assessing available hardware resources (i.e., specifically, processing devices, such as CPUs and GPUs) and, in some embodiments, SDKs for a specified task and, as a result, determining an optimal set of software codes for a specified task that is specific to one or more of the available hardware resources.

Specifically, the invention relies on Artificial Intelligence (AI) including Machine Learning (ML) models. The ML models are trained to generate sets of software code for a specific computerized task. In this regard, the ML models receive inputs that comprise, at a minimum, the available hardware resources and determines at least one set of codes for performing the computerized task with each set of codes seeking to optimize the performance of the computerized task and being dependent on specific available hardware resources (e.g., specific available processing devices). Optimization takes into account at least one, and in some embodiments both, rate/speed of performance and the accuracy of performance.

In specific embodiments, the ML models additionally receive inputs that define user-specified constraints (i.e., specific parameters that define the optimization that the set of software code is required to meet). In such embodiments, the ML models may be configured to generate a single set of hardware resource-dependent software codes that has been determined to be most optimal. In other embodiments of the invention, e.g., when no user-specified constraints are defined, the ML models may be configured to generate multiple sets of software codes, with each set of software codes being dependent on different hardware resources (e.g., different processing devices). In those embodiments of the invention in which multiple sets of software codes result from an ML model, regression testing of the sets of software code is performed to determine which is set of software codes is the most optimal.

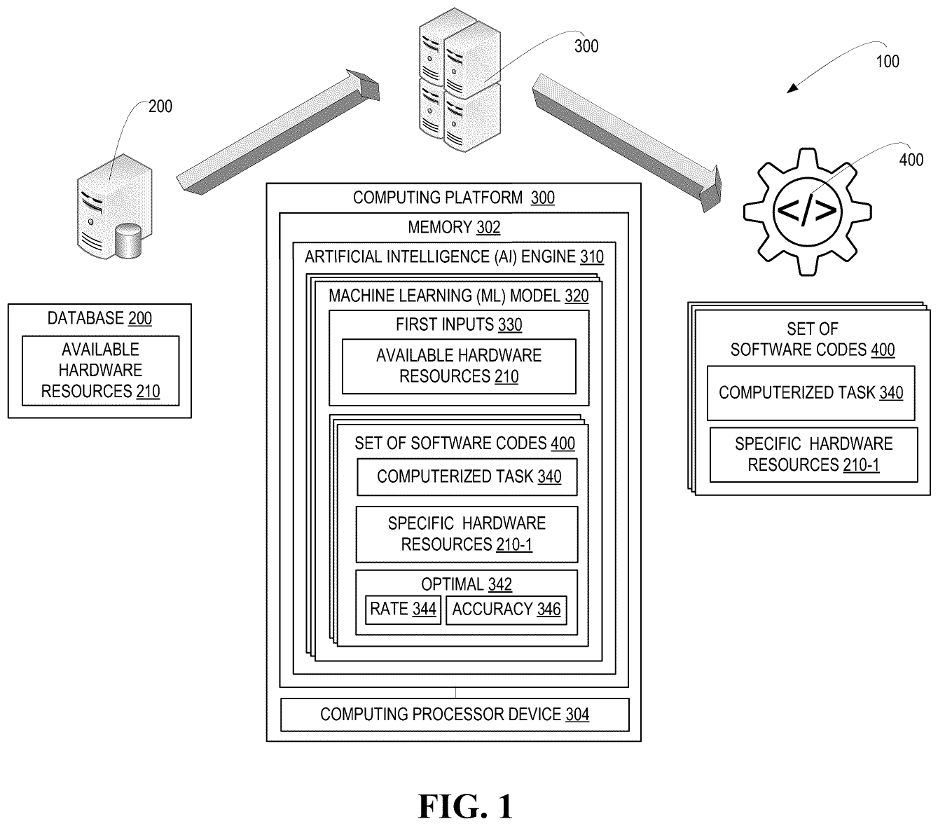

Referring to FIG. 1, a schematic/block diagram is presented of a system 100 for optimizing software code, in accordance with embodiments of the invention. The system 100 is implemented in conjunction with a distributed communication network (not shown in FIG. 1) that may include the Internet, one or more intranets, one or more cellular networks or the like. System 100 includes database 200 that stores parameters/specifications for available hardware resources 210. In specific embodiments of the invention, the hardware resources may include processing units, such as, but not limited to, Central Processing Units (CPUs), Graphics Processing Units (GPUs) and the like. In other embodiments of the invention the hardware resources may include any other hardware resources that impact the optimization of software code. Available hardware resources may include commercially available hardware resources and/or inventoried hardware resources (i.e., hardware resources within an entity/enterprise that are not being used or are being underutilized).

System 100 includes computing platform 300 having memory 302 and one or more computing processor devices 304 in communication with the memory. Memory 304 stores Artificial Intelligence (AI) engine 310 that is executable by one or more of the computing processor device(s) 304. AI engine 310 includes a plurality of Machine Learning (ML) models 320. Each ML model is trained to generate sets of optimized software code 400 for a specific computerized task 340. In this regard, each ML model 320 is configured to receive, at a minimum, first inputs 330 that define currently available hardware resources 210, which includes the parameters/specifications for such hardware resources. In response to receiving the first inputs 330, each ML model 320 is further configured to generate at least one optimized set of software codes 400 for the specific computerized task 340 associated with the corresponding ML model 320. Each set of software codes are specific to at least one of the currently available hardware resources 210 (e.g., specific to (i) a brand/model CPU, (ii) a brand/model GPU or (iii) a brand/model CPU and brand/model GPU). Further, one of the sets of software codes 400 generated by the ML model 320 is the most optimal 342 set of software codes 400 for performing the computerized task 340. Most optimal is defined by at least one (i) a rate/speed at which the specific task is completed, and (ii) an accuracy in completing the task.

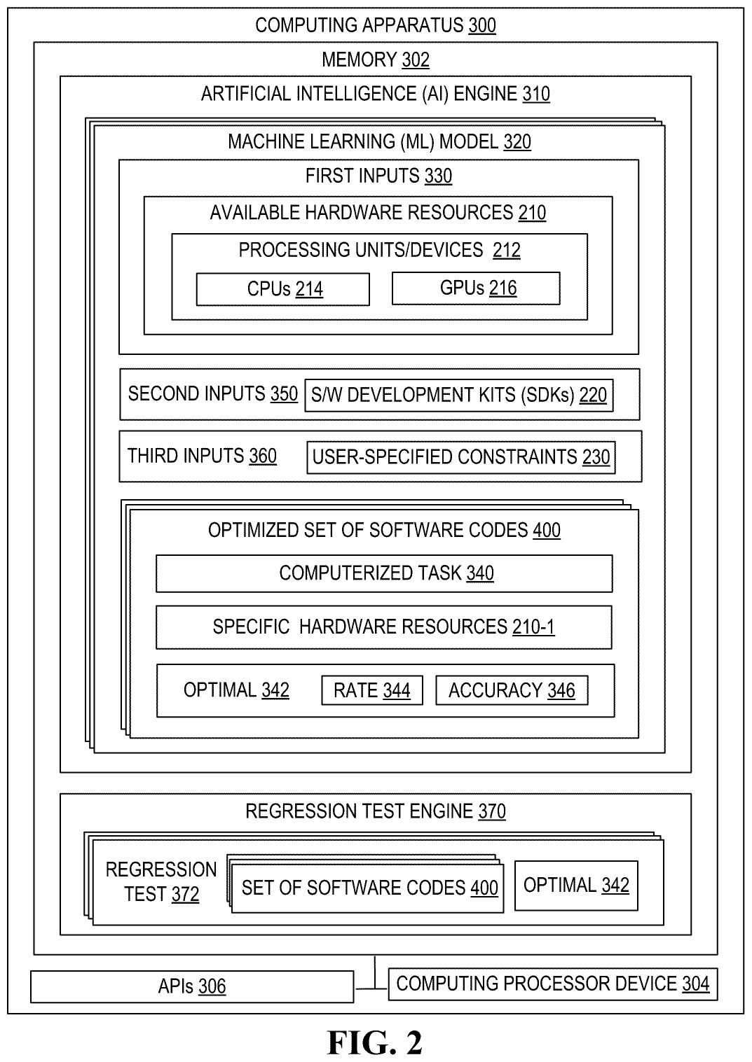

Referring to FIG. 2, a block diagram is presented of computing platform 300, in accordance with embodiments of the present invention. In addition to providing greater details of computing platform 300, FIG. 2 highlights various alternate embodiments of the invention. Computing platform 300 may comprise one or, typically, multiple devices, such as application servers and the like. Computing platform 300 includes memory 302, which may comprise volatile and/or non-volatile memory, such as read-only memory (ROM) and/or random-access memory (RAM), EPROM, EEPROM, flash cards, or any memory common to computing platforms. Moreover, memory may comprise cloud storage, such as provided by a cloud storage service and/or a cloud connection service.

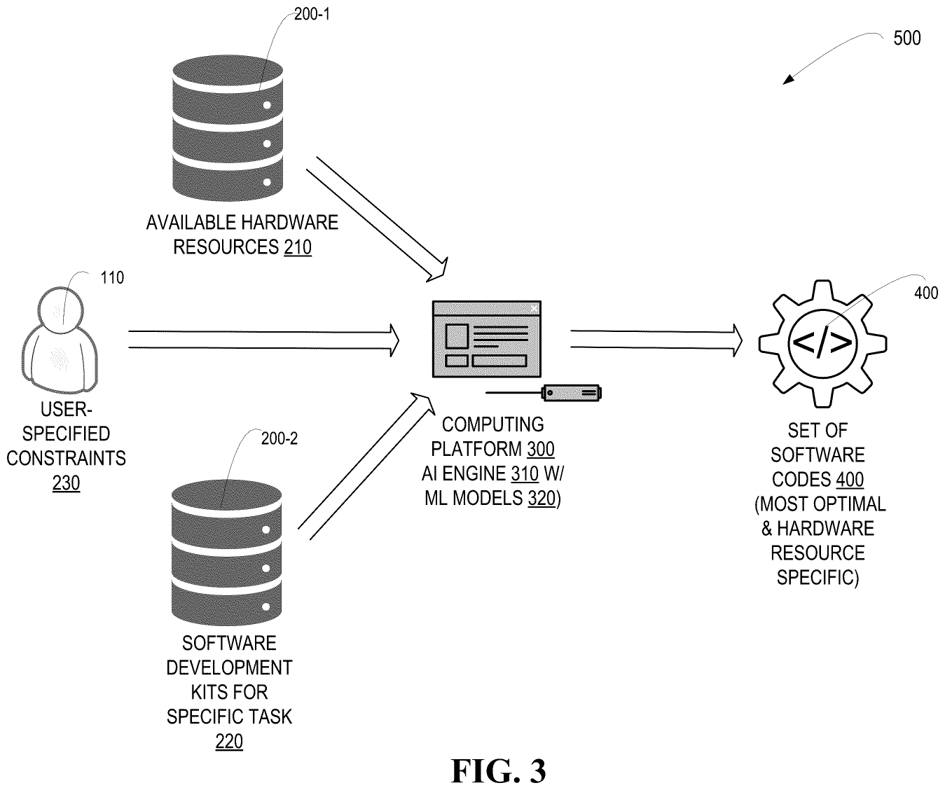

Further, computing platform 300 includes one or more computing processing devices 304, which may be an application-specific integrated circuit (“ASIC”), or other chipset, logic circuit, or other data processing device. Computing processing device(s) 304 may execute one or more application programming interface (APIs) 306 that interface with any resident programs, such as AI engine 310, regression test engine 370 or the like, stored in memory 302 of computing platform 30 and any external programs. Computing platform 300 may include various processing subsystems (not shown in FIG. 3 embodied in hardware, firmware, software, and combinations thereof, that enable the functionality of computing platform 300 and the operability of computing platform 300 on a distributed communication network, such as the Internet, intranet(s), cellular network(s) and the like. For example, processing subsystems allow for initiating and maintaining communications and exchanging data with other networked devices. For the disclosed aspects, processing subsystems of computing platform 300 may include any subsystem used in conjunction with AI engine 310 and regression test engine 370 and related tools, routines, sub-routines, applications, sub-applications, sub-modules thereof.

In specific embodiments of the present invention, computing platform 300 additionally includes a communications module (not shown in FIG. 2) embodied in hardware, firmware, software, and combinations thereof, that enables electronic communications between components of computing platform 300 and other networks and network devices. Thus, communication module may include the requisite hardware, firmware, software and/or combinations thereof for establishing and maintaining a network communication connection with one or more devices and/or networks.

As discussed in FIG. 1, memory 302 of computing platform 300 stores AI engine 310, which is executable by at least one of the one or more computing processor devices 304. AI engine 310 includes a plurality of ML models 320. Each ML model 320 is trained to generate sets of optimized software code 400 for a specific computerized task 340. In this regard, each ML model 320 is configured to receive, at a minimum, first inputs 330 that define currently available hardware resources 210, which includes the parameters/specifications for such hardware resources. In additional embodiments of the invention, ML models 320 are configured to receive second inputs 350 that define Software Development Kits (SDKs) 220 versions specific to the task and/or third inputs 360 that define user-specified constraints 230 (i.e., criteria or the like) used by the ML model 320 to determine the most optimal 342 set of computer codes 400. In specific embodiments of the invention, user-specified constraints 230 define at least one of (i) required time constraints for completing the specific task, (ii) required accuracy constraints for completing the specific task, and (iii) resource acquisition (e.g., cost, availability or the like) constraints for acquiring at least one of the currently available hardware resources 210.

In this regard, each ML model 320 is configured to receive first inputs 330 and optionally second inputs 350 and/or third inputs 360 that define currently available hardware resources 210. In response to receiving the first inputs 330 and, optionally, the second and/or third inputs 350, 360, each ML model 320 is further configured to generate at least one optimized set of software codes 400 for the specific computerized task 340 associated with the corresponding ML model 320. In those embodiments in which third inputs 360 defining user-specified constraints 230 are received, the ML model 320 may be configured to generate one set of software codes 400, which is the most optimal 342 set of software codes 400 that meet the user-specified constraints 230. In other embodiments of the invention, such as when third inputs 360 defining user-specified constraints 230 are not received, the ML model may generate multiple different sets of software code. Each set of software codes that are generated by an ML model 320 are specific to at least one of the currently available hardware resources 210-1 (e.g., specific to (i) a brand/model CPU, (ii) a brand/model GPU or (iii) a brand/model CPU and brand/model GPU). Further, one of the sets of software codes 400 generated by the ML model 320 is the most optimal 342 set of software codes 400 for performing the computerized task 340. Most optimal is defined by at least one (i) a rate/speed at which the specific task is completed, and (ii) an accuracy in completing the task.

Optionally, memory 302 of computing platform 300 includes regression test engine 370, which includes a plurality of regression tests 372 that are executable by at least one of the computing processor device(s) 304. In those embodiments of the invention, in which the ML model 320 generates multiple different sets of software code 400, regression testing is performed to determine which one of the sets of software code is the most optimal 342 set of software codes.

Referring to FIG. 3 a schematic/flow diagram is depicted of a method 500 for intelligent software code optimization, in accordance with embodiments of the present invention. As depicted, the ML models 320 of AI engine 320 receive inputs that define available hardware resources 210 (received from database 200-1), SDKs 220 (received from database 200-2) and user-specified constraints 230 (received from user 110). In response to receiving the inputs, the ML models 320 are executed and single set of software codes 400 is generated by each ML model 320 that is hardware resource-specific and is the most optimal set of software codes for the task. In this regard, the single set of software codes 400, at a minimum, meets the user-specified constraints and may further serve to optimize speed/rate and/or accuracy.

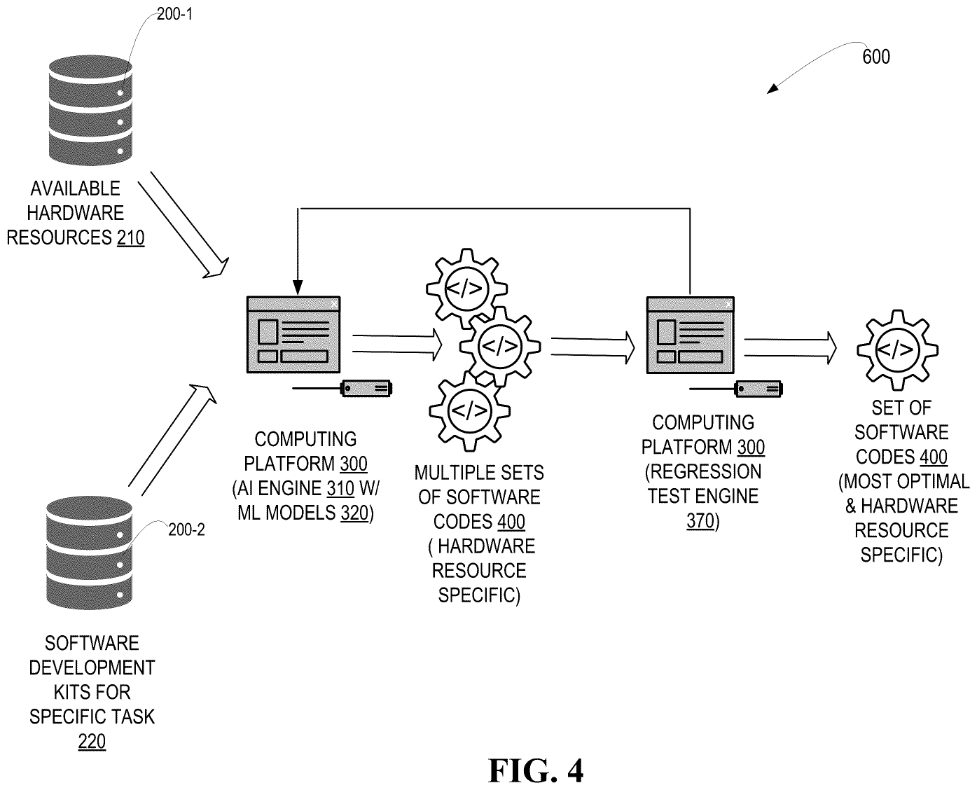

Referring to FIG. 4 a schematic/flow diagram is depicted of a method 600 for intelligent software code optimization, in accordance with embodiments of the present invention. As depicted, the ML models 320 of AI engine 320 receive inputs that define available hardware resources 210 (received from database 200-1), and SDKs 220 (received from database 200-2). However, no inputs defining user-specified constraints 230 (as shown in FIG. 3) are received by the ML models. In response to receiving the inputs, the ML models 320 are executed and multiple different sets of software codes 400 are generated by each ML model 320, with each set of software codes being specific to different hardware resources. In response, regression test engine 370 is executed with regression test(s) being performed on each of the different sets of software codes 400 to determine which one of the sets of software codes 400 is most optimal.

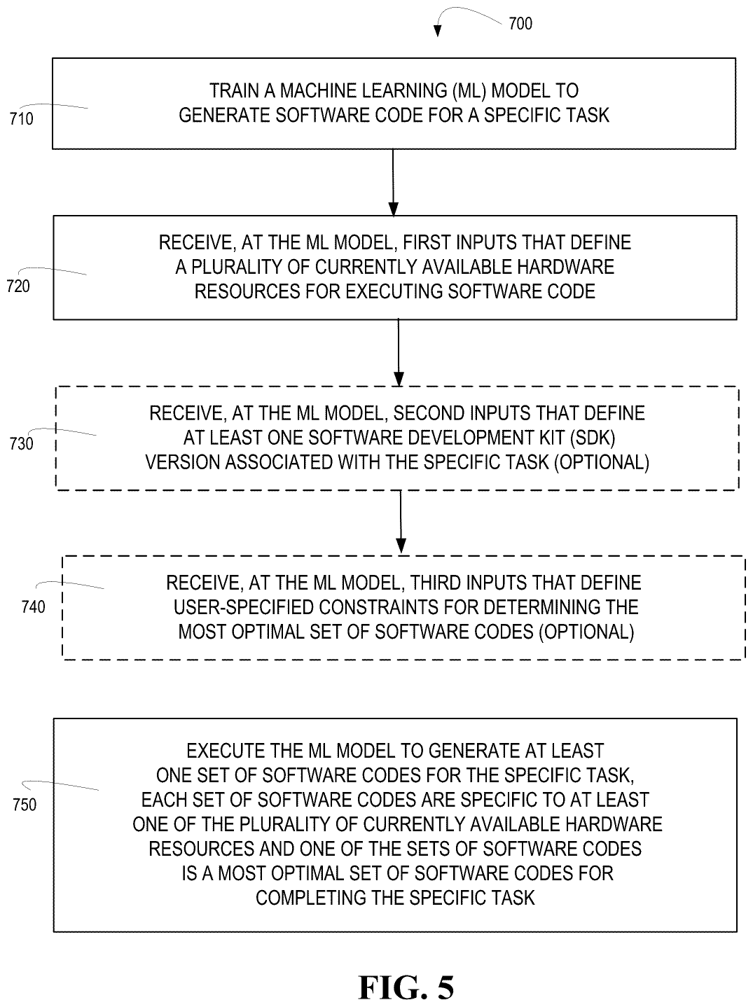

Referring to FIG. 5, a flow diagram is depicted of a method 700 for intelligent optimization of software code, in accordance with embodiments of the present invention. At Event 710, a machine learning (ML) model is trained to generate software code for a specific computerized task. Once the ML model is adequately trained, at Event 720, the ML model receives first inputs that define available hardware resources. In specific embodiments of the invention, the hardware resources may include processing units, such as, but not limited to, Central Processing Units (CPUs), Graphics Processing Units (GPUs) and the like. In other embodiments of the invention the hardware resources may include any other hardware resources that impact the optimization of software code. Available hardware resources may include commercially available hardware resources and/or inventoried hardware resources (i.e., hardware resources within an entity/enterprise that are not being used or are being underutilized).

At optional Event 730, the ML model receives second inputs that define one or more Software Development Kit (SDKs) versions specific to the task. Further, at optional Event 740, the ML model receives third inputs that define user-specified constraints for determining the most optimal set of software codes.

In response to receiving the first inputs and, optionally second and/or third inputs, at Event 750, the ML model is executed to generate at least one set of software codes for performing the associated task. Each set of software codes are specific to at least one of the hardware resources. Typically, when third inputs are received, the ML model will generate a single set of codes that is the most optimal set of computer codes and, if third inputs are not received, the ML model will generate multiple different sets of software codes, each set of software code having different specific hardware resources. In those embodiments of the method, in which multiple sets of software codes are generated, the method may also include regression testing of the multiple different sets of codes to determine which one of the sets of software code is most optimal. Most optimal is defined, at least, in terms of (i) rate/speed of performance of the task and (ii) accuracy of performance of the task.

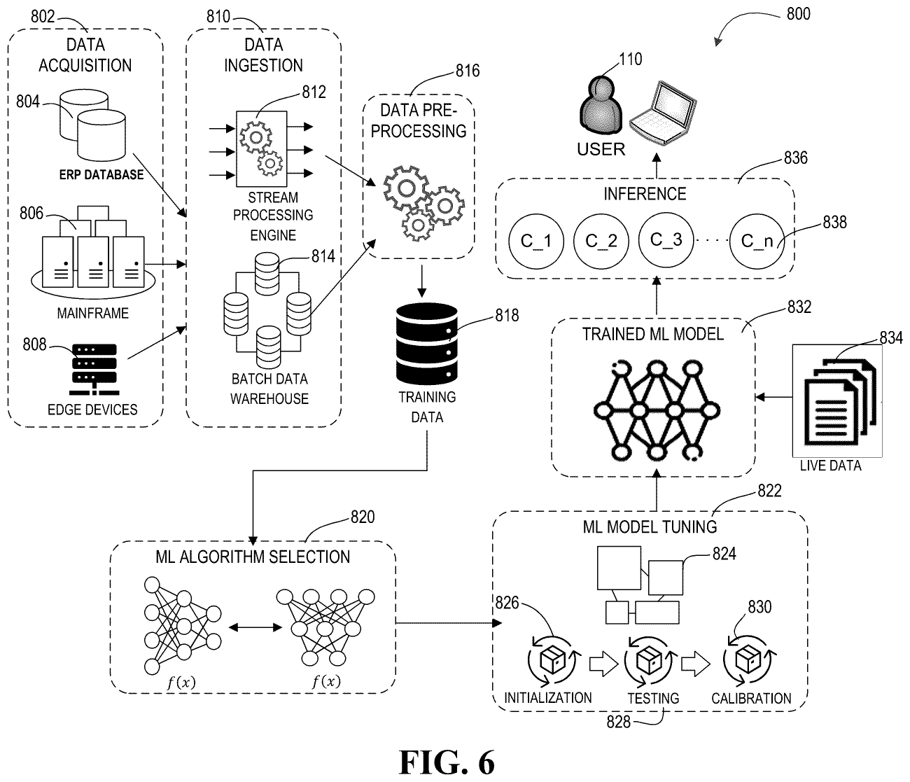

FIG. 6 illustrates an exemplary machine learning (ML) subsystem architecture 800, in accordance with embodiments of the present invention. The machine learning subsystem 800 may include a data acquisition engine 802, data ingestion engine 810, data pre-processing engine 816, ML model tuning engine 822, and inference engine 836.

The data acquisition engine 802 may identify various internal and/or external data sources to generate, test, and/or integrate new features for training the machine learning model 824. These internal and/or external data sources 804, 806, and 808 may be initial locations where the data originates or where physical information is first digitized. The data acquisition engine 802 may identify the location of the data and describe connection characteristics for access and retrieval of data. In some embodiments, data is transported from each data source 804, 806, or 808 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, these data sources may include Enterprise Resource Planning (ERP) databases 804 that host data related to day-to-day business activities such as accounting, procurement, project management, exposure management, supply chain operations, and/or the like, mainframe 806 that is often the entity's central data processing center, edge devices 808 that may be any piece of hardware, such as sensors, actuators, gadgets, appliances, or machines, that are programmed for certain applications and can transmit data over the internet or other networks, and/or the like. The data acquired by the data acquisition engine 802 from these data sources may then be transported to the data ingestion engine 810 for further processing.

Depending on the nature of the data imported from the data acquisition engine 802, the data ingestion engine 810 may move the data to a destination for storage or further analysis. Typically, the data imported from the data acquisition engine 802 may be in varying formats as they come from different sources, including RDBMS, other types of databases, S3 buckets, CSVs, or from streams. Since the data comes from different sources, it needs to be cleansed and transformed so that it can be analyzed together with data from other sources. At the data ingestion engine 802, the data may be ingested in real-time, using the stream processing engine 812, in batches using the batch data warehouse 814, or a combination of both. The stream processing engine 812 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 814 collects and transfers data in batches according to scheduled intervals, trigger events, or any other logical ordering.

In machine learning, the quality of data and the useful information that can be derived therefrom directly affects the ability of the machine learning model 824 to learn. The data pre-processing engine 816 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 816 may implement feature extraction and/or selection techniques to generate training data 818. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 818 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 822 may be used to train a machine learning model 824 using the training data 818 to make predictions or decisions without explicitly being programmed to do so. The machine learning model 824 represents what was learned by the selected machine learning algorithm 820 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, and the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, and the like), an instance-based method (e.g., k-nearest neighbor, learning vector quantization, self-organizing map, and the like), a regularization method (e.g., ridge regression, least absolute shrinkage and selection operator, elastic net, and the like), a decision tree learning method (e.g., classification and regression tree, iterative dichotomiser 3, C4.5, chi-squared automatic interaction detection, decision stump, random forest, multivariate adaptive regression splines, gradient boosting machines, and the like), a Bayesian method (e.g., naïve Bayes, averaged one-dependence estimators, Bayesian belief network, and the like), a kernel method (e.g., a support vector machine, a radial basis function, and the like), a clustering method (e.g., k-means clustering, expectation maximization, and the like), an associated rule learning algorithm (e.g., an Apriori algorithm, an Eclat algorithm, and the like), an artificial neural network model (e.g., a Perceptron method, a back-propagation method, a Hopfield network method, a self-organizing map method, a learning vector quantization method, and the like), a deep learning algorithm (e.g., a restricted Boltzmann machine, a deep belief network method, a convolution network method, a stacked auto-encoder method, and the like), a dimensionality reduction method (e.g., principal component analysis, partial least squares regression, Sammon mapping, multidimensional scaling, projection pursuit, and the like), an ensemble method (e.g., boosting, bootstrapped aggregation, AdaBoost, stacked generalization, gradient boosting machine method, random forest method, and the like), and/or the like.

To tune the machine learning model, the ML model tuning engine 822 may repeatedly execute cycles of experimentation (initialization) 826, testing 828, and calibration/tuning 830 to optimize the performance of the machine learning algorithm 820 and refine the results in preparation for deployment of those results for consumption or decision making. To this end, the ML model tuning engine 822 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 818. A fully trained machine learning model 832 is one whose hyperparameters are tuned and model accuracy maximized.

The trained machine learning model 832, similar to any other software application output, can be persisted to storage, file, memory, or application, or looped back into the processing component to be reprocessed. More often, the trained machine learning model 832 is deployed into an existing production environment to make practical business decisions based on live data 834. To this end, the machine learning subsystem 800 uses the inference engine 836 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 838) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 838) live data 834 based on how similar they are to one another to solve exploratory challenges where little is known about the data, provide a description or label (e.g., C_1, C_2 . . . . C_n 838) to live data 834, such as in classification, and/or the like. These categorized outputs, groups (clusters), or labels are then presented to the user input system 130. In still other cases, machine learning models that perform regression techniques may use live data 834 to predict or forecast continuous outcomes.

It will be understood that the embodiment of the machine learning subsystem 800 illustrated in FIG. 6 is exemplary and that other embodiments may vary. As another example, in some embodiments, the machine learning subsystem 800 may include more, fewer, or different components.

Thus, present embodiments of the invention discussed in detail above, provide for optimizing set(s) of software codes for specific computerized tasks. The invention provides for utilizing ML model trained to determine optimal sets of software code by intelligently assessing available hardware resources (i.e., specifically, processing devices, such as CPUs and GPUs) and, in some embodiments, SDKs for a specified task and, as a result, determining an optimal set of software codes for a specified task that is specific to one or more of the available hardware resources.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for intelligent software code optimization, the system comprising:
a computing platform including a memory and one or more computing processor devices in communication with the memory; and
an Artificial Intelligence (AI) engine stored in the memory, executable by at least one of the one or more computing processing devices and including a plurality of Machine Learning (ML) models, each ML model (i) trained to generate software code for a specific task and (ii) configured to:
receive first inputs that define a plurality of currently available hardware resources for executing software code, and
in response to receiving the first inputs, generate at least one set of software codes for the specific task associated with the ML model, wherein each set of software codes are specific to at least one of the plurality of currently available hardware resources and one of the least one set of software codes is a most optimal set of software codes for completing the specific task, wherein the most optimal is defined by at least one of (i) a rate at which the specific task is completed, and (ii) an accuracy of completing the specific task.

2. The system of claim 1, wherein each ML model is further configured to:
receive the first inputs that define the plurality of currently available hardware resources for executing software code, wherein the plurality of currently available hardware resources include processing units comprising at least one of Central Processing Units (CPUs) and Graphics Processing Units (GPUs), and
in response to receiving the first inputs, generate at least one set of software codes for the specific task associated with the ML model, wherein each set of software codes are specific to at least one of the processing units.

3. The system of claim 1, wherein each ML model is further configured to:
receive second inputs that define at least one Software Development Kit (SDK) version associated with the specific task, and
in response to receiving the first and second inputs, generate at least one set of software codes for the specific task associated with the ML model, wherein each set of software codes are specific to the at least one of the plurality of currently available hardware resources and one of the at least one SDK versions.

4. The system of claim 1, wherein each ML model is further configured to:
receive second inputs that define user-specified constraints for determining the most optimal set of software codes, wherein the user-specified constraints define at least one of (i) required time constraints for completing the specific task, (ii) required accuracy constraints for completing the specific task, and (iii) resource acquisition constraints for acquiring at least one of the currently available hardware resources.

5. The system of claim 4, wherein each ML model is further configured to:
in response to receiving the first and second inputs, generate at least one set of software codes for the specific task associated with the ML model, wherein the at least one set of software codes is one specific set of software codes that is the most optimal set of software codes for completing the task, wherein the most optimal is further defined by the user-specified constraints.

6. The system of claim 1, wherein each ML model is further configured to:
receive first inputs that define the plurality of currently available hardware resources for executing software code, wherein the currently available hardware resources are further defined as chosen from the group consisting of (i) commercially available hardware resources, and (ii) inventoried hardware resources.

7. The system of claim 1, wherein each ML model is configured to:
generate at least one set of software codes for the specific task associated with the ML model, wherein the at least one set of software codes is a plurality of sets of software codes, and
wherein the system further comprises:
a regression test engine stored in the memory, executable by at least one of the one or more computing processor devices and configured to:
perform regression testing on each of the plurality of sets of software codes to determine which one of the plurality of sets of software codes is the most optimal.

8. The system of claim 7, wherein each ML model is further configured to:
learn, over time, by receiving results of regression of regression testing including which one of the plurality of sets of software codes is the most optimal.

9. The system of claim 1, wherein each ML model is further configured to:
receive second inputs that define one or more newly available hardware resources for executing software code, and
in response to receiving the first and second inputs, generate at least one set of software codes for the specific task associated with the ML model, wherein each set of software codes are specific to at least one of the plurality of currently available hardware resources or at least one of the one or more newly available hardware resources and one of the least one set of software codes is a most optimal set of software codes for completing the specific task.

10. A computer-implemented method for intelligently optimizing software code, the method executed by one or more computing processor devices and comprising:
training a Machine Learning (ML) model to generate software code for a specific task;
receiving, at the ML model, first inputs that define a plurality of currently available hardware resources for executing software code; and
in response to receiving the first inputs, executing the ML model to generate at least one set of software codes for the specific task, wherein each set of software codes are specific to at least one of the plurality of currently available hardware resources and one of the least one set of software codes is a most optimal set of software codes for completing the specific task, wherein the most optimal is defined by at least one of (i) a rate at which the specific task is completed, and (ii) an accuracy of completing the specific task.

11. The computer-implemented method of claim 10, wherein receiving further comprises:
receiving, at the ML model, the first inputs that define the plurality of currently available hardware resources for executing software code, wherein the plurality of currently available hardware resources include processing units comprising at least one of Central Processing Units (CPUs) and Graphics Processing Units (GPUs), and
wherein executing further comprises:
executing the ML model to generate at least one set of software codes for the specific task, wherein each set of software codes are specific to at least one of the processing units.

12. The computer-implemented method of claim 10, further comprising:
receiving, at the ML model, second inputs that define at least one Software Development Kit (SDK) version associated with the specific task, and
wherein executing further comprises:
in response to receiving the first and second inputs, executing the ML model to generate at least one set of software codes for the specific task, wherein each set of software codes are specific to the at least one of the plurality of currently available hardware resources and one of the at least one SDK versions.

13. The computer-implemented method of claim 10, further comprising:
receiving, at the ML model, second inputs that define user-specified constraints for determining the most optimal set of software codes, wherein the user-specified constraints define at least one of (i) required time constraints for completing the specific task, (ii) required accuracy constraints for completing the specific task, and (iii) resource acquisition constraints for acquiring at least one of the currently available hardware resources, and
wherein executing further comprises:
in response to receiving the first and second inputs, executing the ML model to generate at least one set of software codes for the specific task, wherein the at least one set of software codes is one specific set of software codes that is the most optimal set of software codes for completing the task, wherein the most optimal is further defined by the user-specified constraints.

14. The computer-implemented method of claim 10, wherein executing further comprises:
executing the ML model to generate at least one set of software codes for the specific task, wherein the at least one set of software codes is a plurality of sets of software codes, and
wherein the computer-implemented method further comprises:
performing regression testing on each of the plurality of sets of software codes to determine which one of the plurality of sets of software codes is the most optimal.

15. The computer-implemented method of claim 10, further comprising:
receiving, at the ML model, second inputs that define one or more newly available hardware resources for executing software code, and
in response to the first and second inputs, re-executing the ML models to generate at least one set of software codes for the specific task, wherein each set of software codes are specific to at least one of the plurality of currently available hardware resources or at least one of the one or more newly available hardware resources and one of the least one set of software codes is a most optimal set of software codes for completing the specific task.

16. A computer program product comprising:
a non-transitory computer-readable medium comprising sets of codes for causing one or more computing devices to:
train a Machine Learning (ML) model to generate software code for a specific task;
receive, at the ML model, first inputs that define a plurality of currently available hardware resources for executing software code; and
in response to receiving the first inputs, execute the ML model to generate at least one set of software codes for the specific task, wherein each set of software codes are specific to at least one of the plurality of currently available hardware resources and one of the least one set of software codes is a most optimal set of software codes for completing the specific task, wherein the most optimal is defined by at least one of (i) a rate at which the specific task is completed, and (ii) an accuracy of completing the specific task.

17. The computer program product of claim 16, wherein the set of codes for causing the one or more computing devices to receive are further configured to cause the one or more computing devices to:
receive, at the ML model, the first inputs that define the plurality of currently available hardware resources for executing software code, wherein the plurality of currently available hardware resources include processing units comprising at least one of Central Processing Units (CPUs) and Graphics Processing Units (GPUs), and
wherein the set of codes for causing the one or more computing device to execute are further configured to cause the one or more computing devices to:
execute the ML model to generate at least one set of software codes for the specific task, wherein each set of software codes are specific to at least one of the processing units.

18. The computer program product of claim 16, wherein the sets of codes further comprises a set of codes for causing the one or more computing devices to:
receive, at the ML model, second inputs that define at least one Software Development Kit (SDK) version associated with the specific task, and
wherein the set of codes configured to cause the one or more computing devices to execute are further configured to cause the one or more computing devices to:
in response to receiving the first and second inputs, execute the ML model to generate at least one set of software codes for the specific task, wherein each set of software codes are specific to the at least one of the plurality of currently available hardware resources and one of the at least one SDK versions.

19. The computer program product of claim 16, wherein the sets of codes further comprise a set of codes for causing the one or more computing devices to:
receive, at the ML model, second inputs that define user-specified constraints for determining the most optimal set of software codes, wherein the user-specified constraints define at least one of (i) required time constraints for completing the specific task, (ii) required accuracy constraints for completing the specific task, and (iii) resource acquisition constraints for acquiring at least one of the currently available hardware resources, and
wherein the set of codes configured to cause the one or more computing devices to execute are further configured to cause the one or more computing devices to:
in response to receiving the first and second inputs, executing the ML model to generate at least one set of software codes for the specific task, wherein the at least one set of software codes is one specific set of software codes that is the most optimal set of software codes for completing the task, wherein the most optimal is further defined by the user-specified constraints.

20. The computer program product of claim 16, wherein the set of codes configured to cause the one or more computing devices to execute are further configured to cause the one or more computing devices to:
execute the ML model to generate at least one set of software codes for the specific task, wherein the at least one set of software codes is a plurality of sets of software codes, and
wherein the sets of codes further comprise a set of codes for causing the one or more computing devices to:
perform regression testing on each of the plurality of sets of software codes to determine which one of the plurality of sets of software codes is the most optimal.
